(19) United States
(12) Patent Application Publication
(10) Pub. No.: US 2010/0000966 A1
(43) Pub. Date: Jan. 7, 2010

(54) METHOD OF MANUFACTURING MAGNETIC RECORDING MEDIUM

(75) Inventors: Yoshiyuki KAMATA, Tokyo (JP); Yosuke ISOWAKI, Yokohama-shi (JP); Kaori KIMURA, Kawasaki-shi (JP); Satoshi SHIROTORI, Yokohama-shi (JP); Masatoshi SAKURAI, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/561,168

(22) Filed: Sep. 16, 2009

Related U.S. Application Data
(63) Continuation of application No. PCT/JP2008/071915, filed on Nov. 26, 2008.

(30) Foreign Application Priority Data
Jan. 31, 2008 (JP) 2008-021904

(51) Int. Cl. B44C 1/22

(52) U.S. Cl. 216/22

(57) ABSTRACT

According to one embodiment, a method of manufacturing a magnetic recording medium includes depositing a magnetic recording layer on a substrate, forming masks on areas corresponding to recording regions of the magnetic recording layer, partially etching the magnetic recording layer in areas not covered with the masks with an etching gas to form protrusions and recesses on the magnetic recording layer, modifying the magnetic recording layer remaining in the recesses with Ne gas to form non-recording regions, and forming a protecting film on an entire surface.

### CROSS-REFERENCE TO RELATED APPLICATIONS

This is a Continuation Application of PCT Application No. PCT/JP2008/071915, filed Nov. 26, 2008, which was published under PCT Article 21(2) in English.

This application is based upon and claims the benefit of priority from Japanese Patent Application No. 2008-021904, filed Jan. 31, 2008, the entire contents of which are incorporated herein by reference.

### BACKGROUND

1. Field

The present invention relates to a method of manufacturing a magnetic recording medium.

2. Description of the Related Art

Recently, in the magnetic recording medium incorporated into hard disk drives (HDDs), there is an increasing problem of disturbance of enhancement of track density due to interference between adjacent tracks. In particular, a serious technical subject is reduction of write blurring due to fringe effect of a magnetic field from a write head.

To solve such a problem, for example, a discrete track recording-type patterned medium (DTR medium) in which recording tracks are physically separated from each other or a bit patterned medium (BPM) in which recording bits are physically separated from each other have been proposed. Since the DTR medium and the BPM can reduce a side-erase phenomenon in writing and a side-read phenomenon in reading, they can increase their track densities and are promising as a high-density magnetic recording medium.

When a medium having an irregular surface formed thereon the DTR medium is read and write with a flying head, flying properties of the head are posed as a problem. For example, when adjacent tracks are to be completely separated from each other in the DTR medium, a layer having a total of about 20 nm, i.e., a magnetic recording layer made of a ferromagnetic material having a thickness of about 15 nm and a protecting layer having a thickness of about 5 nm is removed to form grooves. On the other hand, since a design amount of flying height of the flying head is about 10 nm, it is considered that the flying properties of the head should be ensured by filling the grooves with a nonmagnetic material and flattening the surface of the DTR medium. However, it is difficult to perform the flattening step.

Therefore, methods of locally modifying a flat magnetic recording layer for patterning are proposed (Japanese Patent No. 3886802; Jpn. Pat. Appln. KOKAI Publication No. 5-205257; Jpn. Pat. Appln. KOKAI Publication No. 2005-223177; and Jpn. PCT National Publication No. 2002-501300). Japanese Patent No. 3886802 discloses a method of manufacturing a BPM by causing a part of a magnetic recording layer to react with halogen for modification. Jpn. Pat. Appln. KOKAI Publication No. 5-205257 discloses a method of manufacturing a DTR medium by implanting nitrogen ions into a part of the magnetic recording layer for modification. Jpn. Pat. Appln. KOKAI Publication No. 2005-223177 discloses a method of manufacturing a DTR medium by implanting Ag ions into a part of a magnetic layer to increase a coercivity of the part. Jpn. PCT National Publication No. 2002-501300 discloses a method of patterning a magnetic layer by irradiating a part of the magnetic layer with He ions for modification of magnetic characteristics. These methods enable to form magnetic patterns without forming an irregular surface of a medium, and can provide a DTR medium or a BPM with ensured head flying properties.

It has been found, however, that the methods disclosed in Jpn. Pat. Appln. KOKAI Publication No. 5-205257 and Jpn. PCT National Publication No. 2002-501300 using modification of the magnetic layer by nitrogen ions and He ions, cannot achieve enough separation between recording tracks.

It has been found that a medium manufactured by a method using a reaction with halogen as in Japanese Patent No. 3886802 should be improved in reliability in a high-temperature, high-humidity environment.

Jpn. Pat. Appln. KOKAI Publication No. 2005-223177 is to improve the magnetic characteristics of the irradiated portions by implanting heavy atoms into the magnetic recording layer. The medium has poor head positioning accuracy of about 20 nm, however, which does not satisfy a specified value of 10 nm or less. When the medium surface was observed with a magnetic force microscope (MFM), it was found that a magnetic shape of servo patterns was not favorable. This may be because heavy atom ions with high-energy are diffused to damage the magnetic recording layer.

### SUMMARY OF THE INVENTION

According to an embodiment of the present invention, there is provided a method of manufacturing a magnetic recording medium, comprising: depositing a magnetic recording layer on a substrate; forming masks on areas corresponding to recording regions of the magnetic recording layer; partially etching the magnetic recording layer in areas not covered with the masks with an etching gas to form protrusions and recesses on the magnetic recording layer; modifying the magnetic recording layer remaining in the recesses with Ne gas to form non-recording regions; and forming a protecting film on an entire surface.

According to another embodiment of the present invention, there is provided a method of manufacturing a magnetic recording medium, comprising: depositing a magnetic recording layer on a substrate; forming masks on areas corresponding to recording regions of the magnetic recording layer; partially etching and modifying the magnetic recording layer simultaneously in areas not covered with the masks with a mixture gas of an etching gas and Ne gas to form protrusions and recesses on the magnetic recording layer and non-recording regions in the recesses; and forming a protecting film on an entire surface.

According to still another embodiment of the present invention, there is provided a method of manufacturing a magnetic recording medium, comprising: depositing a magnetic recording layer on a substrate; forming masks on areas corresponding to recording regions of the magnetic recording layer; modifying the magnetic recording layer in areas not covered with the masks with Ne gas to form non-recording regions; and forming a protective film on an entire surface.

### BRIEF DESCRIPTION OF THE SEVERAL VIEWS OF THE DRAWINGS

FIG. 1 is a plane view showing a discrete track recording medium.

FIG. 2 is a plane view showing a bit patterned medium.

FIGS. 3A to 3I are cross-sectional views showing a method of manufacturing a magnetic recording medium according to an embodiment of the present invention.

FIGS. 4A to 4H are cross-sectional views showing a method of manufacturing a magnetic recording medium according to another embodiment of the present invention.

FIGS. 5A to 5H are cross-sectional views showing a method of manufacturing a magnetic recording medium according to still another embodiment of the invention.

FIG. 6 is a cross-sectional view of a DTR medium manufactured by the method of the invention.

FIG. 7 is a cross-sectional view of the DTR medium manufactured by a method of Comparative Example.

### DETAILED DESCRIPTION

In order to solve the above problem, a method of manufacturing a DTR medium and a BPM with patterns of protrusions and recesses having a depth of 10 nm or less on the surface of a magnetic recording layer was studied. The current HDD medium requires a magnetic recording layer with a thickness of about 15 nm to ensure signal output. Therefore, a part of the magnetic recording layer of 5 nm or more is left in the bottoms of the recesses when the patterns of protrusions and recesses having a depth of 10 nm or less are formed. In this state, since the magnetic recording layer remaining in the bottoms of the recesses has an ability to be recorded, a side erase phenomenon and a side read phenomenon cannot be suppressed. Then, the DTR medium and the BPM capable of suppressing the side erase phenomenon and the side read phenomenon are to be manufactured while ensuring the flying properties of the recording head, by demagnetizing the magnetic recording layer of 5 nm or more remaining in the bottoms of the recesses.

It has been found that, in order to demagnetize the magnetic recording layer of 5 nm or more remaining in the bottoms of the recesses, the magnetic recording layer should be exposed to Ne gas. When the magnetic recording layer is exposed to a reactive gas, there is a risk of lowering reliability due to degradation with elapse of time. In the HDD, degradation of the magnetic recording layer and occurrence of corrosion due to reaction with water brings about deteriorated BER. On the contrary, since the Ne gas is inactive, there is no risk of reducing reliability caused by degradation with the elapse of time. Ne is preferable in that it has a small atomic number and a proper mass. Deactivation of the magnetism of the magnetic recording layer is mainly caused through such a mechanism that a locally high temperature occurs in the process of energy loss of the atoms implanted into the ferromagnetic material and damages the crystal structure of the ferromagnetic material. From this viewpoint, it is preferable that the heavy atoms are made to be implanted into the ferromagnetic material. As the atoms are heavier, however, there is a tendency that the atoms are hard to be implanted into the ferromagnetic material in the thickness direction. When the atoms of the ferromagnetic material to be implanted come close to the implanted atoms in mass, sputtering phenomenon occurs. Therefore, the atoms having the similar to the atoms of the ferromagnetic material become rather ineffective of deactivating the magnetism. Conversely, a light atom like He is easily implanted into the ferromagnetic material but it is too light to effectively deactivate the magnetization. In contrast to these atoms, Ne gas has a proper mass and is suitable to demagnetize the ferromagnetic material, and advantageously has low reactivity with water.

Since the Ne gas is effective in deactivating the magnetism of the ferromagnetic material, it is not necessary to form the patterns of protrusions and recesses on the surface of the magnetic recording layer. That is, it has been found that, even by a method of exposing the flat magnetic recording layer to the Ne gas to deactivate the magnetism, the side erase phenomenon and side read phenomenon can be suppressed.

Further, by exposing the ferromagnetic material to the Ne gas, it has been found that a DLC (diamond-like carbon) protective film formed on the surface thereof is improved in quality. Improvement of the protective film in quality contributes to good head flying properties, which brings about further improvement in the signal-to-noise ratio.

Embodiments of the present invention will be described below with reference to the accompanying drawings.

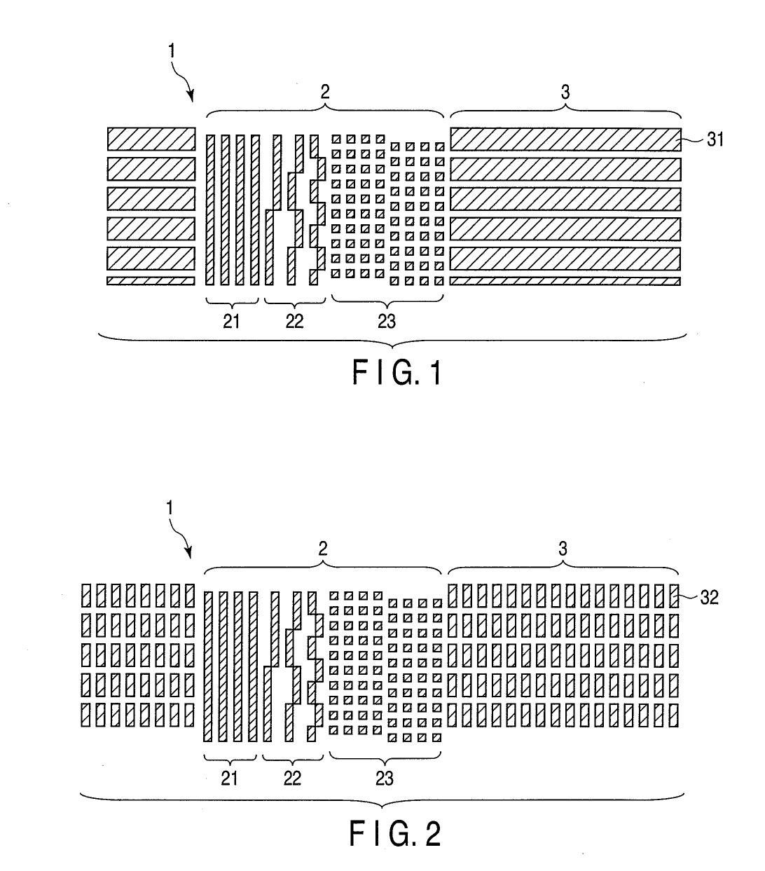

FIG. 1 shows a plane view of a magnetic recording medium (DTR medium) 1 according to an embodiment of the present invention along the circumferential direction. As shown in FIG. 1, servo zones 2 and data zones 3 are alternately formed along the circumferential direction of the DTR medium 1. The servo zone 2 includes a preamble section 21, address section 22, and burst section 23. The data zone 3 includes discrete tracks 31 separated from each other.

FIG. 2 shows a plane view of a magnetic recording medium (BPM) 1 according to another embodiment of the present invention along the circumferential direction. As shown in FIG. 2, the servo zone 2 has the same configuration as that in FIG. 1. The data zone 3 includes recording bits 32 separated from each other.

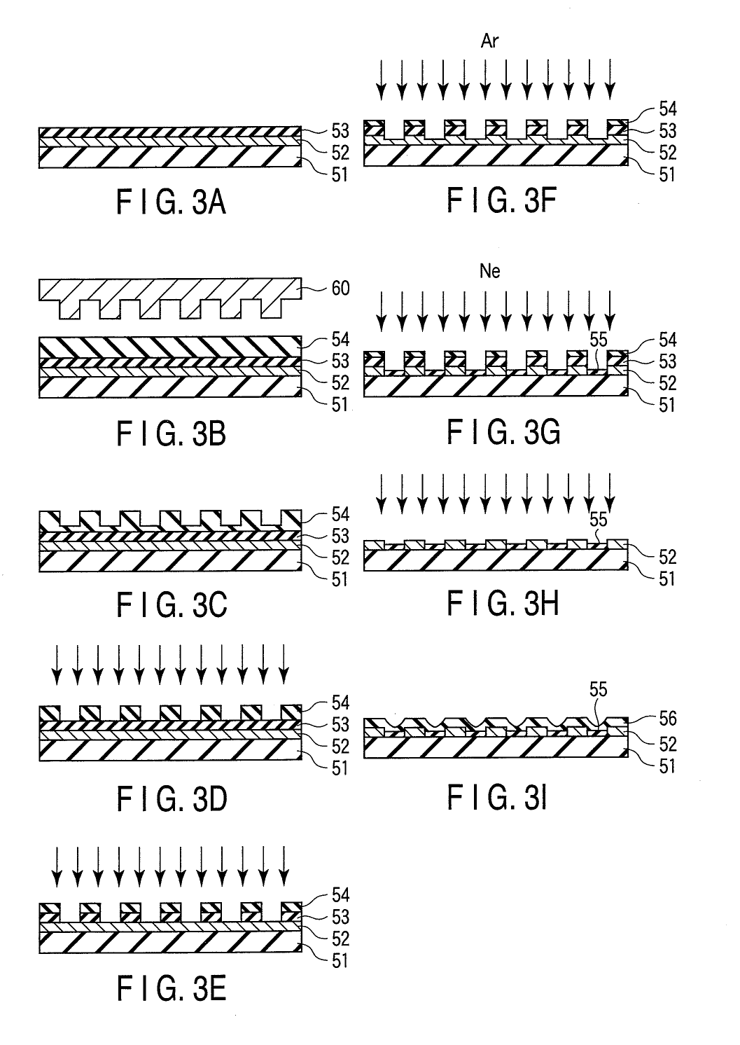

A method of manufacturing a DTR medium or a BPM according to the present invention will be described with reference to FIGS. 3A to 3I.

As shown in FIG. 3A, on a glass substrate 51, a soft magnetic underlayer (not shown) having a thickness of 120 nm and made of CoZrNb, an orientation control underlayer (not shown) having a thickness of 20 nm and made of Ru, a magnetic recording layer 52 having a thickness of 20 nm and made of CoCrPt—SiO₂, and an etching protecting layer 53 having a thickness of 20 nm and made of carbon are sequentially deposited. The soft magnetic underlayer and the orientation control layer are not shown here for descriptive convenience.

As shown in FIG. 3B, spin-on-glass (SOG) is spin-coated on the etching protecting layer 53 as a resist 54 to have a thickness of 100 nm. A stamper 60 is arranged to face the resist 54. On the stamper 60, patterns having protrusions and recesses inverted to those of the magnetic patterns shown in FIG. 1 or 2 are formed.

As shown in FIG. 3C, imprinting is performed by using the stamper 60, and protrusions 54a of the resist 54 are formed corresponding to recesses of the stamper 60. After the imprinting, the stamper 60 is removed.

As shown in FIG. 3D, resist residues left on bottoms of the recesses of the patterned resist 54 are removed. For example, an ICP (inductive coupling plasma) etching apparatus is used, a CF₄ gas is introduced as a process gas, a chamber pressure is set to 2 mTorr, an RF power of a coil and an RF power of a platen are set to 100W, respectively, and an etching time is set to 30 seconds.

As shown in FIG. 3E, the etching protecting layer 53 is patterned using the resist patterns 54 as masks. For example, the ICP etching apparatus is used, an O₂ gas is introduced as a process gas, a chamber pressure is set to 2 mTorr, an RF power of a coil and an RF power of a platen are set to 100W, respectively, and an etching time is set to 30 seconds.

As shown in FIG. 3F, the magnetic recording layer 52 is partially etched by using the patterns of the etching protecting layer 53 as masks to form protrusions and recesses. For example, an ECR (electron cyclotron resonance) ion gun is used, an Ar gas is introduced as a process gas, and etching is performed for one minute at a microwave power of 800W and an acceleration voltage of 500V. In place of Ar serving as the process gas, Kr or Xe may be used. In this manner, recesses each having a depth of 10 nm, for example, are formed on the non-recording regions of the magnetic recording layer 52.

As shown in FIG. 3G, the magnetic recording layer 52 remaining in the recesses are modified (demagnetized) with Ne gas to form non-recording regions 55. The magnetic recording layer 52 remaining in the recesses needs not to be completely demagnetized, and may be set to be prevented from being magnetically recorded. For example, the non-recording regions 55 may be set in a soft magnetic state having a perpendicular coercivity (Hc) of 1 kOe or less although the non-recording regions 55 have magnetization (Ms), or in a paramagnetic state (having no magnetization in the absence of an external magnetic field and slightly magnetized in application of a magnetic field in the direction thereof). The apparatus for exposing the magnetic recording layer with the Ne gas may be an ICP etching apparatus or an ECR ion gun. When the ICP etching apparatus is used, a deactivating effect for magnetism is high because a sample is set in Ne gas plasma. The sample may be damaged, however, by a substrate bias. When the ECR ion gun is used, Ne gas ions can be accelerated to about 2 keV and applied to the sample. For this reason, it is preferable because the Ne gas can be accurately implanted in the depth direction. In this case, an effect of deactivating magnetism is sufficiently exhibited with a process time of about 30 seconds. Even though the process time is elongated, the effect is not considerably changed. This is because the effect of deactivating magnetism with the Ne gas is not rate-determined by diffusion like chemical reactions and depends on the depth that the Ne gas is implanted. The depth of the implanted Ne gas depends not on the process time but on the kinetic energy of the Ne gas atoms. The kinetic energy of the Ne gas atoms is determined by an acceleration voltage in the case of the ECR ion gun and determined by a substrate bias power in the case of the ICP etching apparatus. Note that, if the process time is elongated, the demagnetization effect is increased a little because the absolute number of ionic species are increased.

As shown in FIG. 3H, the patterns of the etching protecting layer (carbon) 53 are removed. For example, RIE (Reactive Ion Etching) is performed using an oxygen gas under conditions of 100 mTorr and 100 W. In general, the resist (SOG) remaining on the patterns of the etching protecting layer 53 is also lifted off. Alternatively, the remaining SOG may be stripped off by RIE using a CF₄ gas, and then carbon is stripped off by RIE using an oxygen gas.

As shown in FIG. 3I, a surface protecting film 56 made of carbon is deposited by CVD (chemical vapor deposition). A lubricant is coated on the surface protecting film 56 to provide a magnetic recording medium according to the present invention.

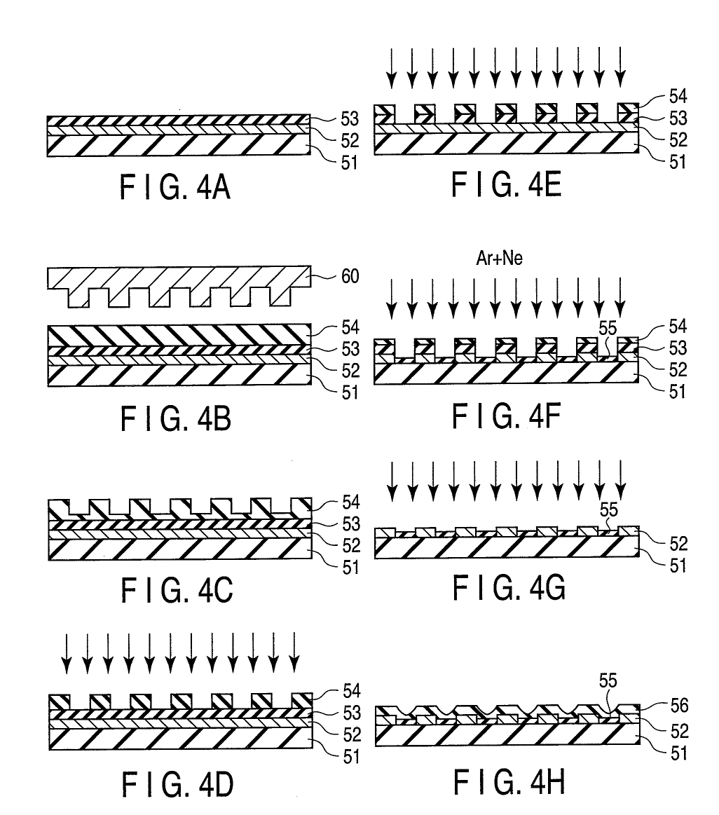

FIGS. 4A to 4H show another method of manufacturing a DTR medium or a BPM according to the present invention. In this method, as shown in FIG. 4F, a part of the magnetic recording layer 52 of areas (non-recording regions) not covered with etching masks is processed with a mixture gas of an etching gas (for example, an Ar gas) and Ne gas to perform etching and modification simultaneously. In this manner, protrusions and recesses are formed on the magnetic recording layer 52, and the non-recording regions 55 are formed in the recesses. That is, the steps of FIGS. 3F and 3G are performed in one step.

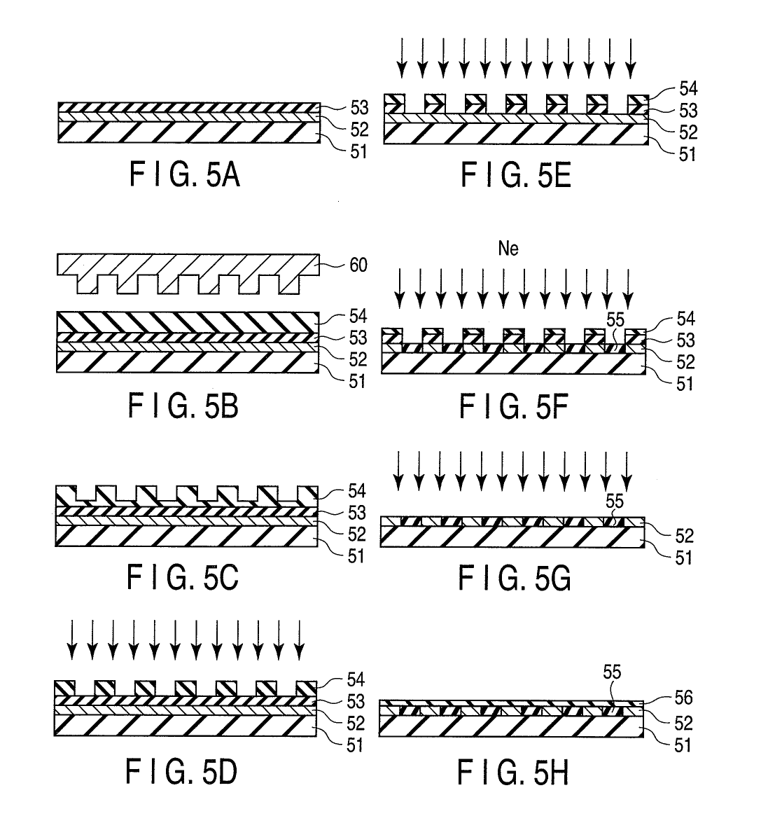

FIGS. 5A to 5H show still another method of manufacturing a DTR medium or a BPM according to the present invention. According to this method, the flat magnetic recording layer 52 is modified with the Ne gas in FIG. 5F without partially etching the magnetic recording layer 52 in the areas (non-recording regions) not covered with the etching masks to form non-recording regions 55.

Next, preferable materials to be used in the embodiments of the present invention will be described.

[Substrate]

As the substrate, for example, a glass substrate, Al-based alloy substrate, ceramic substrate, carbon substrate or Si single crystal substrate having an oxide surface may be used. As the glass substrate, amorphous glass or crystallized glass is used. Examples of the amorphous glass include common soda lime glass and aluminosilicate glass. Examples of the crystallized glass include lithium-based crystallized glass. Examples of the ceramic substrate include common aluminum oxide, aluminum nitride or a sintered body containing silicon nitride as a major component and fiber-reinforced materials of these materials. As the substrate, those having a NiP layer on the above metal substrates or nonmetal substrates formed by plating or sputtering may be used.

[Soft Magnetic Underlayer]

The soft magnetic underlayer (SUL) serves a part of such a function of a magnetic head as to pass a recording magnetic field from a single-pole head for magnetizing a perpendicular magnetic recording layer in a horizontal direction and to circulate the magnetic field to the side of the magnetic head, and applies a sharp and sufficient perpendicular magnetic field to the recording layer, thereby improving read/write efficiency. For the soft magnetic underlayer, a material containing Fe, Ni or Co may be used. Examples of such a material may include FeCo-based alloys such as FeCo and FeCoV, FeNi-based alloys such as FeNi, FeNiMo, FeNiCr and FeNiSi, FeAl-based alloys and FeSi-based alloys such as FeAl, FeAlSi, FeAlSiCr, FeAlSiTiRu and FeAlO, FeTa-based alloys such as FeTa, FeTaC and FeTaN and FeZr-based alloys such as FeZrN. Materials having a microcrystalline structure such as FeAlO, FeMgO, FeTaN and FeZrN containing Fe in an amount of 60 at % or more or a granular structure in which fine crystal grains are dispersed in a matrix may also be used. As other materials to be used for the soft magnetic underlayer, Co alloys containing Co and at least one of Zr, Hf, Nb, Ta, Ti and Y may also be used. Such a Co alloy preferably contains 80 at % or more of Co. In the case of such a Co alloy, an amorphous layer is easily formed when it is deposited by sputtering. Because the amorphous soft magnetic material is not provided with crystalline anisotropy, crystal defects and grain boundaries, it exhibits excellent soft magnetism and is capable of reducing medium noise. Preferable examples of the amorphous soft magnetic material may include CoZr—, CoZrNb— and CoZrTa-based alloys.

An underlayer may further be formed beneath the soft magnetic underlayer to improve the crystallinity of the soft magnetic underlayer or to improve the adhesion of the soft magnetic underlayer to the substrate. As the material of such an underlayer, Ti, Ta, W, Cr, Pt, alloys containing these metals or oxides or nitrides of these metals may be used. An intermediate layer made of a nonmagnetic material may be formed between the soft magnetic underlayer and the recording layer. The intermediate layer has two functions including the function to cut the exchange coupling interaction between the soft magnetic underlayer and the recording layer and the function to control the crystallinity of the recording layer. As the material for the intermediate layer Ru, Pt, Pd, W, Ti, Ta, Cr, Si, alloys containing these metals or oxides or nitrides of these metals may be used.

In order to prevent spike noise, the soft magnetic underlayer may be divided into plural layers and Ru layers with a thickness of 0.5 to 1.5 nm are interposed therebetween to attain anti-ferromagnetic coupling. Also, a soft magnetic layer may be exchange-coupled with a pinning layer of a hard magnetic film such as CoCrPt, SmCo or FePt having longitudinal anisotropy or an anti-ferromagnetic film such as IrMn and PtMn. A magnetic film (such as Co) and a nonmagnetic film (such as Pt) may be provided under and on the Ru layer to control exchange coupling force.

[Magnetic Recording Layer]

For the perpendicular magnetic recording layer, a material containing Co as a main component, at least Pt and further an oxide is preferably used. The perpendicular magnetic recording layer may contain Cr if needed. As the oxide, silicon oxide or titanium oxide is particularly preferable. The perpendicular magnetic recording layer preferably has a structure in which magnetic grains, i.e., crystal grains having magnetism, are dispersed in the layer. The magnetic grains preferably have a columnar structure which penetrates the perpendicular magnetic recording layer in the thickness direction. The formation of such a structure improves the orientation and crystallinity of the magnetic grains of the perpendicular magnetic recording layer, with the result that a signal-to-noise ratio (SN ratio) suitable to high-density recording can be provided. The amount of the oxide to be contained is important to provide such a structure.

The content of the oxide in the perpendicular magnetic recording layer is preferably 3 mol % or more and 12 mol % or less and more preferably 5 mol % or more and 10 mol % or less based on the total amount of Co, Cr and Pt. The reason why the content of the oxide in the perpendicular magnetic recording layer is preferably in the above range is that, when the perpendicular magnetic recording layer is formed, the oxide precipitates around the magnetic grains, and can separate fine magnetic grains. If the oxide content exceeds the above range, the oxide remains in the magnetic grains and damages the orientation and crystallinity of the magnetic grains. Moreover, the oxide precipitates on the upper and lower parts of the magnetic grains, with an undesirable result that the columnar structure, in which the magnetic grains penetrate the perpendicular magnetic recording layer in the thickness direction, is not formed. The oxide content less than the above range is undesirable because the fine magnetic grains are insufficiently separated, resulting in increased noise when information is reproduced, and therefore, a signal-to-noise ratio (SN ratio) suitable to high-density recording is not provided.

The content of Cr in the perpendicular magnetic recording layer is preferably 0 at % or more and 16 at % or less and more preferably 10 at % or more and 14 at % or less. The reason why the content of the Cr is preferably in the above range is that the uniaxial crystal magnetic anisotropic constant Ku of the magnetic grains is not too much reduced and high magnetization is retained, with the result that read/write characteristics suitable to high-density recording and sufficient thermal fluctuation characteristics are provided. The Cr content exceeding the above range is undesirable because Ku of the magnetic grains is lowered, and therefore, the thermal fluctuation characteristics are deteriorated, and also, the crystallinity and orientation of the magnetic grains are impaired, resulting in deterioration in read/write characteristics.

The content of Pt in the perpendicular magnetic recording layer is preferably 10 at % or more and 25 at % or less. The reason why the content of Pt is preferably in the above range is that the Ku value required for the perpendicular magnetic layer is provided, and further, the crystallinity and orientation of the magnetic grains are improved, with the result that the thermal fluctuation characteristics and read/write characteristics suitable to high-density recording are provided. The Pt content exceeding the above range is undesirable because a layer having an fcc structure is formed in the magnetic grains and there is a risk that the crystallinity and orientation are impaired. The Pt content less than the above range is undesirable because a Ku value satisfactory for the thermal fluctuation characteristics suitable to high-density recording is not provided.

The perpendicular magnetic recording layer may contain one or more types of elements selected from B, Ta, Mo, Cu, Nd, W, Nb, Sm, Tb, Ru and Re besides Co, Cr, Pt and the oxides. When the above elements are contained, formation of fine magnetic grains is promoted or the crystallinity and orientation can be improved and read/write characteristics and thermal fluctuation characteristics suitable to high-density recording can be provided. The total content of the above elements is preferably 8 at % or less. The content exceeding 8 at % is undesirable because phases other than the hcp phase are formed in the magnetic grains and the crystallinity and orientation of the magnetic grains are disturbed, with the result that read/write characteristics and thermal fluctuation characteristics suitable to high-density recording are not provided.

As the perpendicular magnetic recording layer, a CoPt-based alloy, CoCr-based alloy, CoPtCr-based alloy, CoPtO, CoPtCrO, CoPtSi, CoPtCrSi, a multilayer structure of an alloy layer containing at least one type selected from the group consisting of Pt, Pd, Rh and Ru and a Co layer, and materials obtained by adding Cr, B or O to these layers, for example, CoCr/PtCr, CoB/PdB and CoO/RhO may be used.

The thickness of the perpendicular magnetic recording layer is preferably 5 to 60 nm and more preferably 10 to 40 nm. When the thickness is in this range, a magnetic recording apparatus suitable to higher recording density can be manufactured. If the thickness of the perpendicular magnetic recording layer is less than 5 nm, read outputs are too low and noise components tend to be higher. If the thickness of the perpendicular magnetic recording layer exceeds 40 nm, read outputs are too high and the waveform tends to be distorted. The coercivity of the perpendicular magnetic recording layer is preferably 237000 A/m (3000 Oe) or more. If the coercivity is less than 237000 A/m (3000 Oe), thermal fluctuation resistance tends to be deteriorated. The perpendicular squareness of the perpendicular magnetic recording layer is preferably 0.8 or more. If the perpendicular squareness is less than 0.8, the thermal fluctuation resistance tends to be deteriorated.

[Protective Layer]

The protective layer is provided for the purpose of preventing corrosion of the perpendicular magnetic recording layer and also preventing the surface of a medium from being damaged when the magnetic head is brought into contact with the medium. Examples of the material of the protective layer include those containing C, SiO₂ or ZrO₂. The thickness of the protective layer is preferably 1 to 10 nm. This is preferable for high-density recording because the distance between the head and the medium can be reduced. Carbon may be classified into sp²-bonded carbon (graphite) and sp³-bonded carbon (diamond). Though sp³-bonded carbon is superior in durability and corrosion resistance to graphite, it is inferior in surface smoothness to graphite because it is crystalline material. Usually, carbon is deposited by sputtering using a graphite target. In this method, amorphous carbon in which sp²-bonded carbon and sp³-bonded carbon are mixed is formed. Carbon in which the ratio of sp³-bonded carbon is larger is called diamond-like carbon (DLC). DLC is superior in durability and corrosion resistance and also in surface smoothness because it is amorphous and therefore utilized as the surface protective layer for magnetic recording media. The deposition of DLC by CVD (chemical vapor deposition) produces DLC through excitation and decomposition of raw gas in plasma and chemical reactions, and therefore, DLC richer in sp³-bonded carbon can be formed by adjusting the conditions.

Next, preferred manufacturing conditions in each process in the embodiments of the present invention will be described.

[Imprinting]

A resist is applied to the surface of a substrate by spin-coating and then, a stamper is pressed against the resist to thereby transfer the patterns of the stamper to the resist. As the resist, for example, a general novolak-type photoresist or spin-on-glass (SOG) may be used. The surface of the stamper on which patterns of protrusions and recesses corresponding to servo information and recording tracks are formed is made to face the resist on the substrate. In this process, the stamper, the substrate and a buffer layer are placed on the lower plate of a die set and are sandwiched between the lower plate and the upper plate of the die set to be pressed under a pressure of 2000 bar for 60 seconds, for example. The height of the protrusions of the patterns formed on the resist by imprinting is, for instance, 60 to 70 nm. The above conditions are kept for about 60 seconds for transporting the resist to be excluded. In this case, if a fluorine-containing peeling agent is applied to the stamper, the stamper can be peeled from the resist satisfactorily.

[Removal of Resist Residues]

Resist residues left on the bottoms of the recesses of the resist are removed by RIE (reactive ion etching). As the plasma source, ICP (inductively coupled plasma) apparatus capable of producing high-density plasma under a low pressure is preferable, but an ECR (electron cyclotron resonance) plasma or general parallel-plate RIE apparatus may be used. When SOG is used as the resist, fluorine gas RIE is used. When novolac-based photoresist is used as the resist, oxygen RIE is used.

[Etching of Magnetic Recording Layer]

After the resist residues are removed, the magnetic recording layer is processed using the resist patterns as etching masks. For the processing of the magnetic recording layer, etching using Ar ion beams (Ar ion milling) is preferable. The processing may be carried out by RIE using Cl gas or a mixture gas of CO and NH₃. In the case of RIE using the mixture gas of CO and NH₃, a hard mask made of Ti, Ta or W is used as an etching mask. When RIE is used, a taper is scarcely formed on the side walls of the protruded magnetic patterns. In processing the magnetic recording layer by Ar ion milling capable of etching any material, if etching is carried out under the conditions that, for example, the acceleration voltage is set to 400V and incident angle of ions is varied between 30° and 70°, a taper is scarcely formed on the side walls of the protruded magnetic patterns. In milling using an ECR ion gun, if etching is carried out under static opposition arrangement (incident angle of ions is 90°), a taper is scarcely formed on the side walls of the protruded magnetic patterns.

[Stripping of Resist]

After the magnetic recording layer is etched, the resist is stripped off. When a general photoresist is used as the resist, it can be easily stripped off by oxygen plasma treatment. Specifically, the photoresist is stripped off by using an oxygen ashing apparatus under the conditions that the chamber pressure is 1 Torr, power is 400 W and processing time is 5 minutes. When SOG is used as the resist, SOG is stripped off by RIE using fluorine-containing gas. As the fluorine-containing gas, CF₄ or SF₆ is suitable. Note that, it is preferable to carry out rinsing with water because the fluorine-containing gas reacts with moisture in the atmosphere to produce an acid such as HF and H₂SO₄.

[Deposition of Protective Layer and Aftertreatment]

Then, a carbon protective layer is deposited. The carbon protective layer is preferably be deposited by CVD to improve coverage to the irregular surface, but it may be deposited by sputtering or vacuum evaporation. CVD produces a DLC film containing a large amount of sp³-bonded carbon. The carbon protective layer with a thickness less than 2 nm is not preferable because it results in unsatisfactory coverage. Whereas, a carbon protective layer with a thickness exceeding 10 nm is not preferable because it increases magnetic spacing between a read/write head and a medium, leading to a reduction in SNR. A lubricant is applied to the surface of the protective layer. As the lubricant, for example, perfluoropolyether, fluorinated alcohol, fluorinated carboxylic acid or the like is used.

### EXAMPLES

Example 1

A magnetic recording layer was processed by the method shown in FIGS. 3A to 3I using a stamper on which the patterns of protrusions and recesses of the servo patterns (preamble, address, and burst) and the recording tracks are formed as shown in FIG. 1. In the modifying step of FIG. 3G, an ECR ion gun was used, and the surface of a sample was exposed to Ne gas at an acceleration voltage of 1000V. After the magnetic recording layer was processed, a DLC protecting film was formed and a lubricant was coated so that a DTR medium was manufactured.

When the resultant DTR medium was evaluated for a glide test, the medium passed the glide test using a 8-nm flying head.

When the resultant DTR medium was mounted on a drive and measured for on-track BER (bit error rate), the power of −4.5 was obtained. The positioning accuracy of the read/write head was 6 nm. Also, the medium was evaluated for a fringe test as an index of the side-read and side-erase as described below. More specifically, recording was performed on a center track and then the BER was measured. Recording was performed on an adjacent track hundred thousand times, and then the BER of the center track was measured again to examine degradation in BER. As a result, degradation in BER was not observed, showing preferable fringe resistance.

Furthermore, when the medium was evaluated for reliability test at a temperature of 65° C. and a humidity of 80%, degradation in BER was not observed even 96 hours later.

The DTR medium manufactured by the method according to the embodiment exhibited good head flying properties and good head positioning accuracy, showing high fringe resistance.

Comparative Example 1

A DTR medium was manufactured by the same method as that in Example 1 except that the modifying step of FIG. 3G was omitted. When the resultant DTR medium was evaluated for a glide test, the medium passed the glide test using a 10-nm flying head but the medium produced glide noise in the glide test using a 8-nm flying head. When the resultant DTR medium was mounted on a drive and measured for on-track BER, the power of −4.3 was obtained. The positioning accuracy of the read/write head was 6 nm. When the medium was evaluated for a fringe test, degradation in BER was not observed when recording was performed on an adjacent track fifty times, but the BER was lowered to the power of −3.0 when recording was performed on the adjacent track one thousand times.

The reason for degradation in characteristics of the DTR medium according to Comparative Example 1 is as follows. More specifically, when a modifying step using the Ne gas is not performed, a damage layer 52a due to Ar ions is formed on the surface of the magnetic recording layer 52 in the recesses as shown in FIG. 7. When the damage layer 52a is formed in such a manner, it degrades the quality of the surface protecting film 56 made of DLC formed thereon, and further degrades the surface state of the lubricant applied to the surface protecting film 56. Therefore, the on-track BER may be deteriorated. The reason why the fringe resistance is degraded is due to the fact that the magnetic recording layer 52 remaining in the recesses are recorded where magnetization is generated and the side-erase and side-read cannot be suppressed.

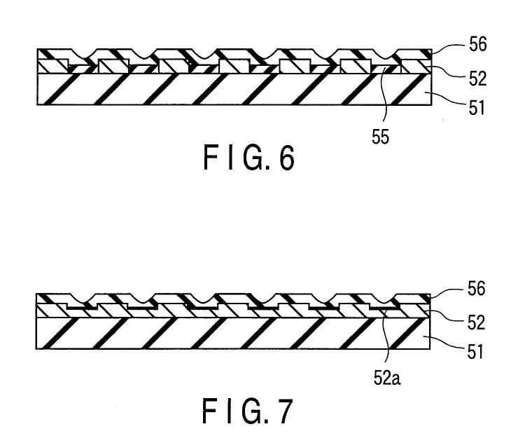

In contrast to this, in the DTR medium according to Example 1, when the non-recording regions 55 are formed in the recesses by a process using the Ne gas, the surface damage layer is also modified as shown in FIG. 6. This brings about an effect of improving adhesion between the non-recording regions 55 and the surface protecting film 56 made of DLC formed thereon, and further improves the surface state of the lubricant applied thereto. For this reason, the medium of the Example 1 shows a preferable on-track BER.

### Example 2

A DTR medium was manufactured by the method shown in FIGS. 4A to 4H. More specifically, in the step of FIG. 4F, etching and modification of the magnetic recording layer were simultaneously performed by using a mixture gas of Ar and Ne. The mixing ratio of the Ar gas to the Ne gas was set to 80% to 20% (flow rates of Ar and Ne were 20 sccm and 5 sccm), processing was performed with an ECR ion gun at an acceleration voltage of 1000V and adjusted such that the depth of the recesses was 10 nm.

When the resultant DTR medium was evaluated for a glide test, the medium passed the glide test using a 8-nm flying head. When the resultant DTR medium was mounted on a drive and measured for on-track BER, the power of −4.5 was obtained. The positioning accuracy of the read/write head was 6 nm. When the medium was evaluated for a fringe test, the medium exhibited preferable fringe resistance. When the medium was evaluated for reliability test at a temperature of 65° C. and a humidity of 80%, degradation in BER was not observed even 96 hours later.

The same evaluation as described above was performed such that the mixing ratio of the Ar gas to the Ne gas used in the step of FIG. 4F was varied. As the Ne content increases, the time required for deactivating magnetism of the magnetic recording layer was shortened, though the etching rate was reduced. This is because the effect of deactivating magnetism becomes higher as the Ne gas concentration is high. In order to simultaneously perform etching and modification of the magnetic recording layer in the step of FIG. 4F, the mixing ratio of the Ar gas in the mixture gas is preferably set to 5% or more and 95% or less (the mixing ratio of the Ne gas is set to 95% or less and 5% or more). In order to realize sufficient deactivation of magnetism in the process time required to form recesses having a depth of 10 nm on the magnetic recording layer, the mixing ratio of the Ne gas is preferably set to 10 to 50%.

Example 3

A magnetic recording layer was processed by the method shown in FIG. 3A to 3J using a stamper on which the patterns of protrusions and recesses of the servo patterns (preamble, address, and burst) and the recording tracks are formed as shown in FIG. 2. In the modifying step of FIG. 3G, an ECR ion gun was used, and the surface of a sample was exposed to a Ne gas at an acceleration voltage of 1000V. After the magnetic recording layer was processed, a DLC protecting film was formed and a lubricant was coated so that BPM was manufactured.

When the resultant BPM was evaluated for a glide test, the medium passed the glide test using a 8-nm flying head.

Since the BER cannot be defined in a BPM, the medium was evaluated for signal amplitude intensity. When the resultant BPM was mounted on a drive such that the magnetic recording layer was magnetized in one direction and a reproduction waveform was observed, a signal amplitude intensity of 200 mV was obtained. The positioning accuracy of the read/write head was 6 nm. When the medium was evaluated for reliability test at a temperature of 65° C. and a humidity of 80%, degradation in BER was not observed even 96 hours later.

Example 4

Patterns were transferred using a stamper having the patterns of protrusions and recesses of the servo patterns (preamble, address, burst) and recording tracks as shown in FIG. 1. In the modification process of FIG. 5F, an ECR ion gun was used to expose the surface of a sample with Ne gas at the acceleration voltage of 1000V, without etching the magnetic recording layer. Then, the etching protective film was removed, a DLC protective film was formed, and a lubricant is applied thereto, thereby manufacture a DTR medium.

When the surface of the resultant DTR medium was observed with an AFM (atomic force microscope), the medium had a flat surface with almost no irregularity. When the resultant BPM was evaluated for a glide test, the medium passed the glide test using a 8-nm flying head.

When the resultant DTR medium was mounted on a drive and measured for on-track BER, the power of −4.8 was obtained. The positioning accuracy of the read/write head was 6 nm. When the medium was evaluated for a fringe test, the medium exhibited preferable fringe resistance.

Further, when the medium was evaluated for reliability test at a temperature of 65° C. and a humidity of 80%, degradation in BER was not observed even 96 hours later.

Since the DTR medium manufactured in this method has a flat surface without irregularity, the flying properties of the read/write head is quite well, leading to better BER than that of the conventional DTR medium. A medium manufactured by a method in which a reactive gas or a heavy atom are implanted (Japanese Patent No. 3886802; Jpn. Pat. Appln. KOKAI Publication No. 5-205257; and Jpn. Pat. Appln. KOKAI Publication No. 2005-223177) has poor head positioning accuracy. On the contrary, the process using the Ne gas according to the invention would not deteriorate the domain shape of the servo patterns and brings about satisfactory BER, since the Ne atoms are easily implanted into the magnetic recording layer in the perpendicular direction owing to the Ne gas of a light atom.

As described above, the DTR medium or the BPM manufactured by the method according to the present invention can ensure good flying properties of the read/write head, good head positioning accuracy, a high signal S/N, and can be stably used in a high-temperature, high-humidity environment. Furthermore, since the quality of the DLC protecting film is improved, BER can be improved.

What is claimed is:

1. A method of manufacturing a magnetic recording medium, comprising:
depositing a magnetic recording layer on a substrate;
forming masks on areas corresponding to recording regions of the magnetic recording layer;
partially etching the magnetic recording layer in areas not under the masks with an etching gas to form protrusions and recesses on the magnetic recording layer;
modifying the magnetic recording layer in the recesses with neon (Ne) gas to form non-recording regions; and
forming a protecting film on an entire surface.

2. The method of claim 1, wherein argon (Ar) is used as the etching gas.

3. A method of manufacturing a magnetic recording medium, comprising:
depositing a magnetic recording layer on a substrate;
forming masks on areas corresponding to recording regions of the magnetic recording layer;
partially etching and modifying the magnetic recording layer simultaneously in areas not under the masks with a mixture gas of an etching gas and Ne gas to form protrusions and recesses on the magnetic recording layer and non-recording regions in the recesses; and
forming a protecting film on an entire surface.

4. The method of claim 3, wherein Ar is used as the etching gas.

5. A method of manufacturing a magnetic recording medium, comprising:
depositing a magnetic recording layer on a substrate;
forming masks on areas corresponding to recording regions of the magnetic recording layer;
modifying the magnetic recording layer in areas not under the masks with Ne gas to form non-recording regions; and
forming a protective film on an entire surface.
